(19) United States
(12) Patent Application Publication
(10) Pub. No.: US 2003/0141440 A1
(43) Pub. Date: Jul. 31, 2003

(54) Multi-type fiber bragg grating sensor system

(75) Inventors: Jong-Woo Kim, Amsa-Dong (KR); Chul Chung, Dongjak-Gu (KR); Ki-Soo Kim, Songnam-City (KR)

Correspondence Address: BROWN, MARTIN, HALLER & MCCLAIN LLP, 1660 UNION STREET, SAN DIEGO, CA, 92101-2926, US

(73) Assignee: ICES CO., LTD., Asan-City (KR)

(21) Appl. No.: 10/112,328

(22) Filed: Mar. 27, 2002

(30) Foreign Application Priority Data
Jan. 28, 2002 (KR) 2002-0004778

(51) Int. Cl. G01J 1/34

(52) U.S. Cl. 250/227.21

(57) ABSTRACT

A multi-type Fiber Bragg Grating Sensor System adapted to use on inclined chirped grating filter and to discharge light at a predetermined period of interval, enabling to accurately detect at one time wavelength variation amount of light signals reflected from the multiple FBG sensors, the system comprising: a light emitting diode driving unit for driving a light emitting diode in response to a timing signal produced therein to prompt the light emitting diode to repeatedly emit light signals; multiple FBG sensors for receiving the light signals emitted from the light emitting diode via a light coupler to reflect the light which changes its center wavelength according to externally-applied physical properties changes; an inclined chirped grating filter for allowing the light signals respectively reflected from each FBG sensors to pass the different amount of luminous intensity according to the center wavelength change; first detector for detecting the luminous intensity of each light signal having passed the inclined chirped grating filter; second detector for detecting luminous intensity of each light signal reflected from the FBG sensor; divider for dividing the luminous intensity detected by the first detector by the luminous intensity detected by the second detector; and a controller for storing a luminous intensity variation rate (n) currently input from the divider and comparing with a variation rate (n−1) priorly input to obtain a value of wavelength change based on the difference between them and to calculate physical properties variations applied to each FBG sensor in response to the wavelength change.

### BACKGROUND OF THE INVENTION

1. Field of the Invention

The present invention relates to a multi-type Fiber Bragg Grating (FBG) sensor system, and more particularly to a multi-type FBG sensor system adapted to use one inclined chirped grating filter and to discharge pulsed light at a predetermined period of interval, enabling to deal with the light signals reflected from multiple FBG sensors at the same time.

2. Description of the Prior Art

FBG actively being developed as a optical fiber sensor is used for fiber laser and filter, pulse compression and so on. The advantage of FBG is that it can be useful for multi point measurements and several of them can be inserted into a single fiber to enable to measure physical variations at different points.

The FBG sensor is made by constructing a periodical refractive index change within a fiber core, and a central wavelength of light signals reflected from the FBG sensor in response to external physical property changes is as varied as physical property changes. As a result, if wavelength change is detected, physical property changes can be calculated.

FIG. 1 is a block diagram for illustrating a structure of multi-type FBG sensor system according to the prior art, where the system includes a light emitting diode 1, a light coupler 2, a light sensor 3, a Fabry-Perot (F-P) filter, a light diode 5, a filter driver 6 and a detector 7.

The light diode 1 serves to emit a light signal having a predetermined wavelength and light intensity. The sensor part 3, functioning to receive the light signal emitted from the light emitting diode 1 via the light coupler 2 to transit and reflect a center wavelength in response to physical changes such as externally-applied temperatures, strains, consists of multiple FBG sensors (FBG1˜FBGn).

The light signal reflected from the sensor part 3 is transferred to the F-P filter 4 via the light coupler 2, where the F-P filter 4 allows the reflected light signal to pass at the center wavelength while a light signal could not pass the filter at the other wavelengths.

The light diode 5 transforms the light intensity which has passed the F-P filter 4 to a electric voltage, while the filter driver 6 gradually increases the voltage to a Piezo-Electric Transducer (PZT) inside the F-P filter 4 to thereby change the center wavelength of the F-P filter 4.

The detector 7 detects wavelength change based on the PZT voltage where the central wavelength of the F-P filter 4 and the central wavelength of the received light diode 5 are accorded in response to changes of the central wavelength at the light sensor 3 according to externally-applied physical variations.

### SUMMARY OF THE INVENTION

However, there is a problem in the multi-type FBG sensor system thus described according to the prior art in that a tunable F-P filter is used to detect wavelength variations at FBGs, thereby taking very long time to scan the wavelength of light signals reflected from each FBG and making it difficult to obtain an accurate detection due to hysteresis at the PZT attached to the F-P filter during the scanning process.

The present invention is disclosed to solve the aforementioned problems and it is an object of the present invention to provide a multi-type Fiber Bragg Grating sensor system adapted to use a single inclined chirped grating filter and to emit light at a predetermined period of time, thereby enabling to accurately and rapidly detect wavelength changes of light signals reflected from the multiple Fiber Bragg Grating sensors at one time.

In accordance with the object of the present invention, there is provided a multi-type FBG sensor system, the system comprising:

a light emitting diode driving unit for driving a light emitting diode in response to a timing signal produced therein to prompt the light emitting diode to repeatedly emit light signals;

multiple FBG sensors for receiving the light signals emitted from the light emitting diode via a light coupler to reflect the light which changes its center wavelength according to externally-applied physical properties changes;

an inclined chirped grating filter for allowing the light signals respectively reflected from each FBG sensors to pass the different amount of luminous intensity according to the center wavelength change;

first detecting means for detecting the luminous intensity of each light signal having passed the inclined chirped grating filter;

second detecting means for detecting luminous intensity of each light signal reflected from the FBG sensor;

divider for dividing the luminous intensity detected by the first detecting means by the luminous intensity detected by the second detecting means; and

a controller for storing a luminous intensity variation rate (n) currently input from the divider and comparing with a variation rate (n−1) priorly input to obtain a value of wavelength change based on the difference between them and to calculate physical properties variations applied to each FBG sensor in response to the wavelength change.

### BRIEF DESCRIPTION OF THE DRAWINGS

For fuller understanding of the nature and objects of the invention, reference should be made to the following detailed description taken in conjunction with the accompanying drawings in which:

FIG. 1 is a block diagram for illustrating a construction of a multi-type FBG sensor system according to the prior art;

FIG. 2 is a block diagram for illustrating a construction of a multi-type FBG sensor according to the present invention;

FIG. 3 is a timing diagram for illustrating of a light signal emitted from a light emitting diode according to the present invention;

FIG. 4 is a spectrum of a light signal emitted from a light emitting diode according to the present invention;

FIG. 5 is a spectrum of a light signal reflected from a FBG sensor according to the present invention;

FIG. 6 is a transmission characteristic drawing of an inclined chirped grating filter according to the present invention; and

FIG. 7 is a block diagram for illustrating a multi-type FBG sensor system by time division system according to the present invention.

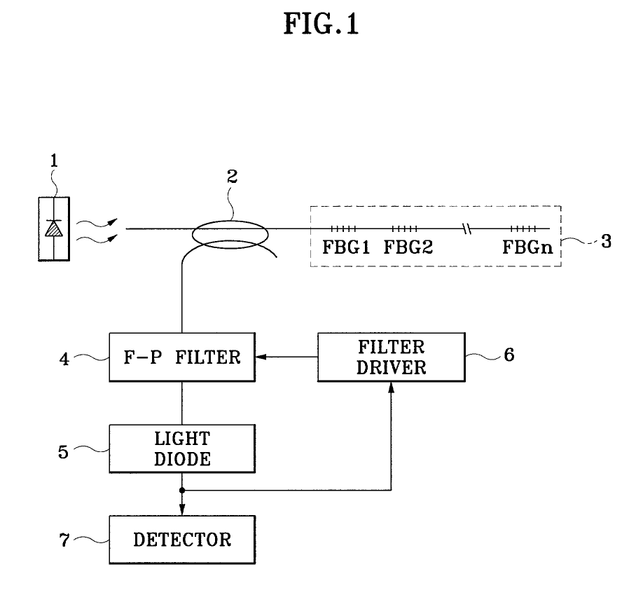

### DETAILED DESCRIPTION OF THE INVENTION

Now, preferred embodiment of the present invention is described with reference to the accompanying drawings.

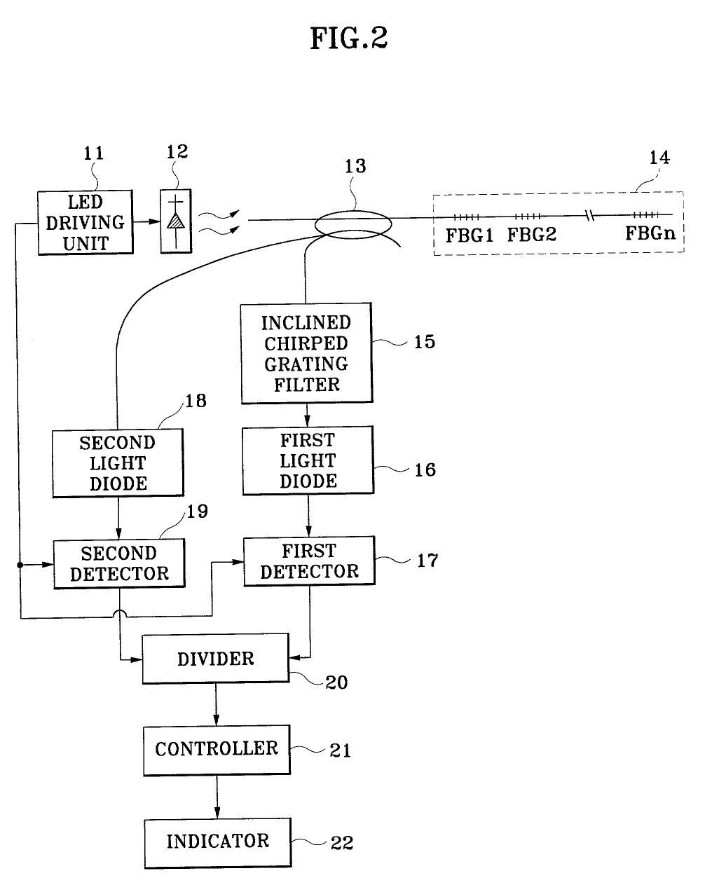

FIG. 2 is a block diagram for illustrating a structure of a multi-type FBG sensor system by code division multiple access method according to the present invention, where the sensor system includes an light emitting diode driving unit 11, a light emitting diode 12, a light coupler 13, a light sensor 14, an inclined grating filter 15, a first light diode 16, a first detector 17, a second light diode 18, a second detector 19, a divider 20, a controller 21 and an indicator 22.

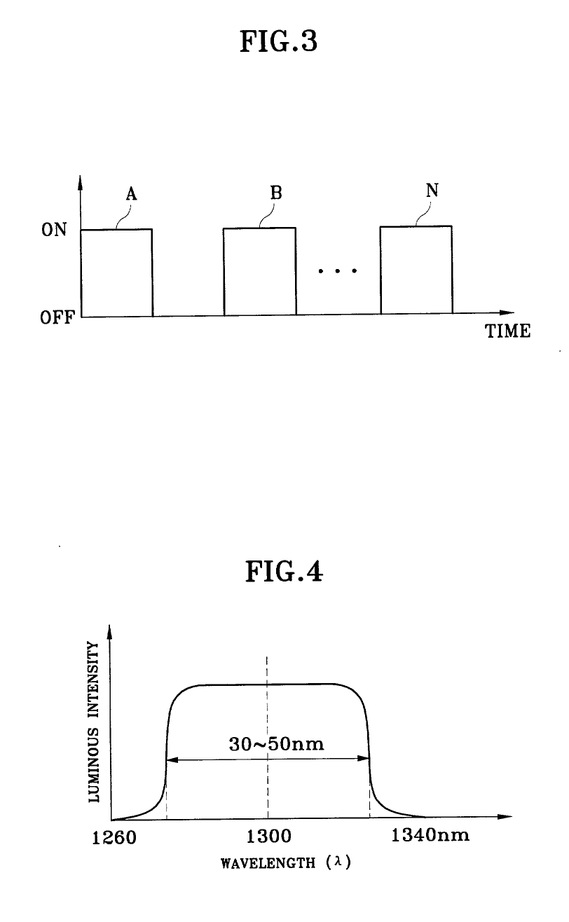

The light emitting diode driving unit 11 serves to drive the light emitting diode 12 based on a Pseudo Random Binary Sequence (PRBS) signal or a pulse signal having a predetermined period of time generated from within. The light emitting diode 12 is driven by the light emitting diode driving unit 11 to output light signals (A˜N) at a predetermined period of time as illustrated in FIG. 3, where each light signal has a predetermined wavelength (by way of example, central wavelength 1300 nm, wavelength width 30˜50 nm) and a predetermined luminous intensity, as shown in FIG. 4.

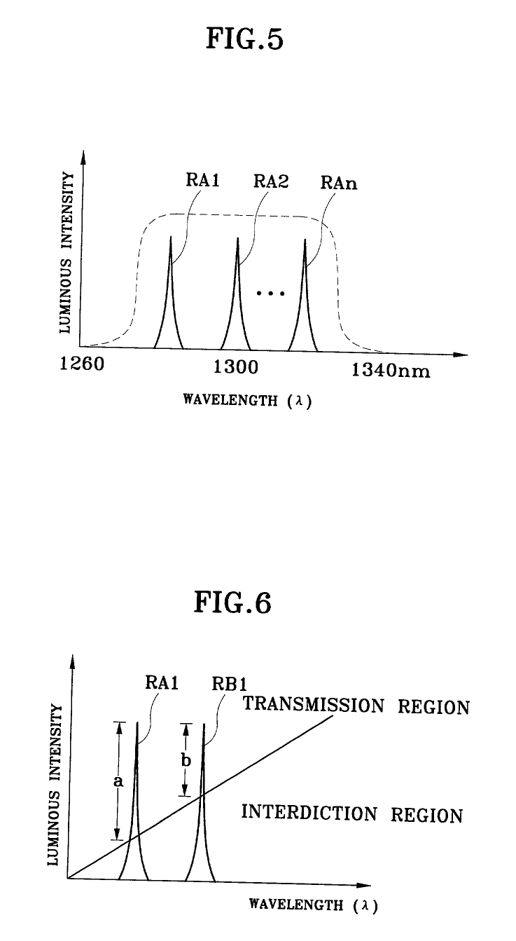

The light sensor 14 receives the light signals emitted from the light emitting diode 12 via the light coupler 13 to transit and reflect the central wavelength thereof in response to physical properties variations such as externally-applied temperatures, strains, where a multiplicity of optical Fiber Bragg Grating sensors (FBG1˜FBGn) are arranged in series within a single fiber each at a predetermined distance, and as the sensors (FBG1˜FBGn) have different central wavelengths respectively, light signals (RA1˜RAn) reflected from each FBG (FBG1˜FBGn) at the light sensor 14 are different in wavelengths thereof as illustrated in FIG. 5.

Furthermore, the inclined chirped grating filter 15 receives the light signals (RA1˜RAn) reflected from the light sensor 14 to allow the light signals (RA1˜RAn) to pass therethrough in different luminous intensity relative to wavelength changes.

At this time, a filter having the transmission characteristic thus described may be a chirped grating filter manufactured by Blue Road Research. The filter is not limited thereof but any optical device filter having the same transmission characteristic as that of general grating filter such as long period gratings or WDM coupler.

In other words, as illustrated in FIG. 6, the inclined chirped grating filter 15 passes the light signals reflected from the light sensor 14 with gradual increase of luminous intensity as the central wavelength thereof becomes shorter while the filter 15 passes the signals with gradual decrease of luminous intensity for longer central wavelength. At this time, central wavelengths of light signals (RA1˜RAn) reflected from the light sensor 14 vary such that transmitted luminous intensity of each signal varies in value thereof.

The first light diode 16 transforms to a voltage signal the transmission power of light signal having passed the inclined grating filter 15 and outputs same.

The first detector 17 delays for a predetermined period of time the PRBS signals or pulse signals of predetermined period of time generated from the light emitting diode 11 to determined the detecting point, where a voltage signal output from the first light diode 16 is detected.

Furthermore, the second light diode 18 receives the reflected light signals (RA1˜RAn) reflected from the light sensor 14 via the light coupler 13 to convert the luminous intensity of each light signal to electric voltage.

The second detector 19 delays for a predetermined period of time the pulse signal or PRBS signal generated from the light emitting diode driving unit 11 to determine the detection time from which, the electric voltage from the second diode 18 is detected.

The divider 20 divides the luminous intensity detected by the first detector 17 by the luminous intensity detected by the second detector 19.

The controller 21 compares the current luminous intensity change rate (n) input from the divider 20 with the luminous intensity (n−1) priorly input and stored therein to obtain a change of wavelength based on the difference obtained from the comparison. The physical properties change applied to each Fiber Bragg Grating (FBG1˜FBGn) is calculated based on the properties wavelength change thus obtained. The indicator 22 serves to indicate the physical changes calculated from the controller 21.

Now, operation and effect of the multi-type FBG sensor system is described in detail as shown in FIGS. 3, 4, 5 and 6.

As illustrated in FIG. 3, when the light emitting diode driving unit 11 drives the light emitting diode 12 to prompt the light emitting diode 12 to emit a first light signal (A), the first light signal (A) is transmitted to the FGB sensors 14 via the light coupler 13. The light signal (A) has a predetermined wavelength and luminous intensity as shown in FIG. 4.

When the light signal (A) is transmitted to the FGB sensors 14, each grating (FBG1˜FBGn) sensor reflects light of narrow bandwidth in response to interval change of grating to reflect respective reflected light signals (RA1˜RAn) as shown in FIG. 5. At this time, center wavelength of each reflected light signal are different.

The reflected light signals go to the inclined chirped grating filter 15 through the light coupler 13, where the filter 15, as illustrated in FIG. 6, varies the luminous intensity of each reflected light signal after transmission with respect to changes of center wavelengths.

The reflected light signals having passed the inclined chirped grating filter 15 go to the first light diode 16 which in turn transforms the input reflected light signal to electric voltage to output to the first detector 17.

Furthermore, each light signal (RA1˜RAn) reflected from each FBG (FBG1˜FBGn) sensor is goes to the second light diode 18, which in turn transforms it to electric voltage and send the voltage to the second detector 19.

The first and second detector 17 and 19 delays for a predetermined period of time the pulse signal or the PRBS signal created from the light diode driving unit 11 to determined the detecting point, where luminous intensity of reflected light signals output from the first and second diode 16 and 18 is detected.

In case, the first and second detector 17 and 19 delays for a predetermined period of time to perform the detecting operation when a timing signal generated from the light emitting diode driving unit 11 is a pulse signal of a predetermined period of time, and the timing signal is a PRBS signal, the first and second detector 17 and 19 use correlator and integrator to effect the detecting operation.

In other words, the FBG sensors are fixed in their positions such that light signals reflected from the sensor always have predetermined delayed times respectively. As a result, the light signals are delayed as much as the delayed times from the generated points of the timing signals to perform the detecting operation such that value of luminous intensity of the light signals reflected from the related FBG sensors can be detected.

Successively, the divider 20 divides the luminous intensity detected from the first detector 17 by the luminous intensity detected from the second detector 19 to output same to the controller 21.

In other words, the amount of wavelength changes for the light signals reflected from the FBG sensors are represented in the changes of luminous intensity, where luminous intensity of light signals created from the light emitting diode 12 are not constant according to wavelength such that in order to compensate the same, luminous intensity of light signals detected from the inclined grating filter is divided by the luminous intensity of light signals reflected from the FBG sensors to enable to accurately detect the change rate of luminous intensity of the light signals transmitted through the inclined chirped grating filter. Successively, the controller 21 stores the change rate of luminous intensity input from the divider 20 at a memory.

When a second light signal (B) is output from the light emitting diode 12 to be transmitted to the fiber sensor 14 via the light coupler 13, the change rate of luminous intensity relative to the second light signal is input to the controller 21 through the same process as that of the first light signal (A).

Furthermore, the controller 21 compares the luminous intensity change rate (n) relative to the second light signal (B) input from the divider 20 with the light intensity change rate (n−1) relative to the first light signal (A) priorly input and stored to obtain a wavelength change based on the difference in values, and based on the wavelength change, amount of external physical properties change applied to the fiber sensors 14 can be detected.

At this time, if the luminous intensity of the first light signal (A) and that of the second light signal are the same, amount of wavelength change can be obtained based on a difference value (a-b) between the luminous intensity (a) detected and stored on the first light signal (A) and the luminous intensity (b) currently detected based on the second light signal (B).

Furthermore, it should be noted that positions of the FBG sensors are fixed, light signals reflected from the sensors have a predetermined lag time respectively at all times, and the amount of wavelength changeable to the physical change amount externally applied by the light signals reflected from the respective FBG sensors is already restricted such that the controller 21 is able to confirm whether luminous intensity change rate input from the divider 20 is a value detected based on a particular light signal reflected from a certain FBG sensor, and values thus obtained from the light signals reflected from a certain FBG sensor are compared with previous values to obtain the amount of wavelength variation.

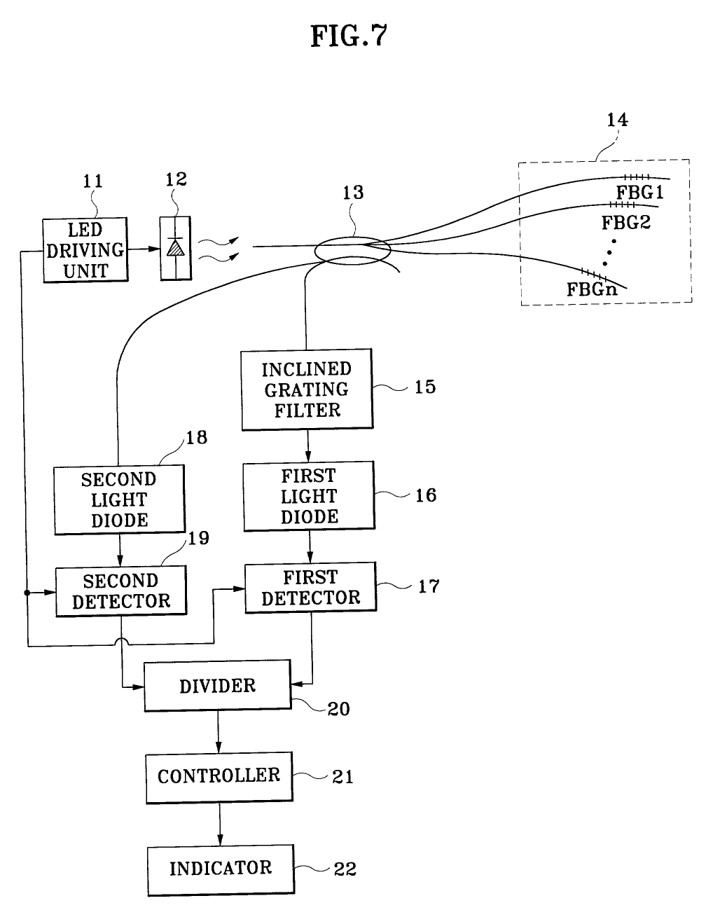

Meanwhile. FIG. 7 is a block diagram for illustrating a multi-type FBG sensor system of time division method according to the present invention, where most of the construction is the same as the sensor system by the code division multiple access method illustrated in FIG. 2 except for the construction at the light sensor 14.

In the light sensor 14, a multiplicity of FBG sensors (FGB1˜FGBn) are respectively inserted into the multiplicity of optical fibers, and with variations at the length of each optical fiber, light signals reflected from each sensor are reflected in mutually different time intervals, whereby same central wavelengths can be available for each FBG sensor.

As apparent from the foregoing, there is an advantage in the multi-type FBG sensor system thus described according to the present invention in that one inclined chirped grating filter is used and light is emitted at a predetermined period of time to enable to accurately detect at one time the wavelength change of light signals reflected from the multiple of FBG sensors.

We claim:

1. A multi-type Fiber Bragg Grating (FBG) sensor system, the system comprising:
a light emitting diode driving unit for driving a light emitting diode in response to a timing signal produced therein to prompt the light emitting diode to repeatedly emit light signals;
multiple FBG sensors for receiving the light signals emitted from the light emitting diode via a light coupler to reflect the light which changes its center wavelength according to externally-applied physical properties changes;
an inclined chirped grating filter for allowing the light signals respectively reflected from each FBG sensors to pass the different amount of luminous intensity according to the center wavelength change;
first detecting means for detecting the luminous intensity of each light signal having passed the inclined chirped grating filter;
second detecting means for detecting luminous intensity of each light signal reflected from the FBG sensor;
divider for dividing the luminous intensity detected by the first detecting means by the luminous intensity detected by the second detecting means; and
a controller for storing a luminous intensity variation rate (n) currently input from the divider and comparing with a variation rate (n−1) priorly input to obtain a value of wavelength change based on the difference between them and to calculate physical properties variations applied to each FBG sensor in response to the wavelength change.

2. The system as defined in claim 1, wherein the multiplicity of FBG sensors are arranged in series in a single fiber each at a predetermined distance with different center wavelengths.

3. The system as defined in claim 1, wherein the multiple FBG sensors are arranged in parallel in different optical fiber with different length from the connector and each has same wavelength.

4. The system as defined in claim 1, wherein a timing signal created from the light emitting diode driving unit is a pulse signal having a predetermined period of time.

5. The system as defined in claim 1, wherein the timing signal created from the light emitting diode driving unit is a Pseudo Random Binary Sequence signal.

6. The system as defined in claim 1 further comprising an indicator for indicating physical properties change amount calculated from the controller.
